(19) United States
(12) Patent Application Publication
(10) Pub. No.: US 2003/0095277 A1
(43) Pub. Date: May 22, 2003

(54) Apparatus and method for image processing and print system

(76) Inventors: Akira Murakawa, Osaka (JP); Kenji Masaki, Nagaokakyo-shi (JP); Hirotomo Ishii, Osaka (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 09/880,963

(22) Filed: Jun. 15, 2001

(30) Foreign Application Priority Data
Jun. 15, 2000 (JP) 2000-179873

(51) Int. Cl. G06F 15/00; G06F 3/12

(52) U.S. Cl. 358/1.14; 358/1.11

(57) ABSTRACT

A print system has an image processor which processes data and a printer which prints data received from the image processor. In the print system, a first converter converts the input data to output data by processing the input data according to data type, while a detector detects a specified pattern in the converted data. All the converted data passes the detector, so that the specified pattern is detected surely or the detection of the image is not missed. Further, a second converter converts the converted data according to data type to data of output colors of an image output device, and the detector detects the specified pattern in the further converted data. Thus, an image having a color close to the original one can be detected surely.

This application is based on application No. 2000-179873 filed in Japan, the contents of which are hereby incorporated by reference.

### BACKGROUND OF THE INVENTION

1. Field of the Invention

The present invention relates to image processing for preventing forgery of paper money, securities and the like.

2. Description of Prior Art

Recently, a peripheral of a computer such as a scanner or a color printer has improved functions and higher performance, and an average consumer can copy paper money, securities and the like easily. Then, effective countermeasures for preventing forgery have been developed. One of methods for preventing forgery is to include a specified pattern in a design of paper money or the like. The specified pattern is embedded in an image so as not to be noticed by a user in the standpoint of prevention of forgery. Image data is analyzed before printing, and when the specified pattern is detected in the image data, normal print operation is stopped.

However, there are various routes of image data from an input device to an output device. When print data received is converted to bit map data to be printed in the printer, different conversion processing is performed according to the data type of input print data. For example, if input image data is a vector data, a calculation based on the vector is performed for conversion to bit map data. If input image data is a text data, it is converted to bit map data with reference to the font data. That is, according to the various types of input data, there are various types of routes of data processing. Therefore, it is not easy to surely detect a specified pattern by analyzing input data and by acquiring an image data.

### SUMMARY OF THE INVENTION

An object of the present invention is to detect image data of a specified pattern surely when an image is outputted.

A print system according to the invention has an image processor which processes data and a printer which prints data received from the image processor. In the print system, a first converter converts the input data to output data by processing the input data according to data type, while a detector detects a specified pattern in the converted data. All the converted data passes the detector, so that the specified pattern is detected surely. Further, a second converter converts the converted data according to data type to data of output colors of an image output device. Thus, the detector detects the specified pattern in the further converted data.

An advantage of the present invention is that the detection of an image which has to be inhibited to be outputted is not missed so that forgery can be prevented surely.

Another advantage of the present invention is that an image having a color close to the original one can be detected surely.

### BRIEF DESCRIPTION OF THE DRAWINGS

These and other objects and features of the present invention will become clear from the following description taken in conjunction with the preferred embodiments thereof with reference to the accompanying drawings, and in which:

FIG. 1 is a diagram of a print system;

FIG. 2 is a diagram of a flow of data processing;

FIG. 3 is a flowchart of detection of a specified pattern in a detection processor;

FIG. 4 is a block diagram of image processing in a printer driver;

FIG. 5 is flowchart of color change;

FIG. 6 is a block diagram of image processing in a printer driver;

FIG. 7 is a flowchart of color change in a print controller;

FIG. 8 is a block diagram of a print system using a spooler; and

FIG. 9 is a block diagram of another print system using a spooler.

### DETAILED DESCRIPTION OF THE PREFERRED EMBODIMENTS

Referring now to the drawings, wherein like reference characters designate like or corresponding parts throughout the several views, examples of a print system of the invention are explained.

In a print system incorporating a function of forgery prevention, a specified pattern included in a design of a paper money or the like is detected in image data. When the specified pattern is detected, output of the image data is inhibited. There are various routes of image data from an input device to an output device. By taking into account that the output of image onto a paper is a final object of printing, when image data is acquired, it is best to set a means for forgery prevention at a position near the output device. Particularly, it is most effective to set the means for forgery prevention at a position in a driver or the like provided for the output device where the image data can be acquired surely. In order to acquire image data surely, because input data passes through various routes, image data for detection are acquired after the conversion according to data types. Further, in order to detect that the output image has the same color as the true original image, the output color has to be found at the position for detection. Then, when detection for forgery prevention is incorporated, it is set at a position where all the data passes, so that forgery prevention can be performed surely and effectively. For example, it is a position where the R (red), G (green) and B (blue) values received for the detection can correspond to the output colors of printing, or a position where the image data passes always in the printer driver. Various examples are explained below.

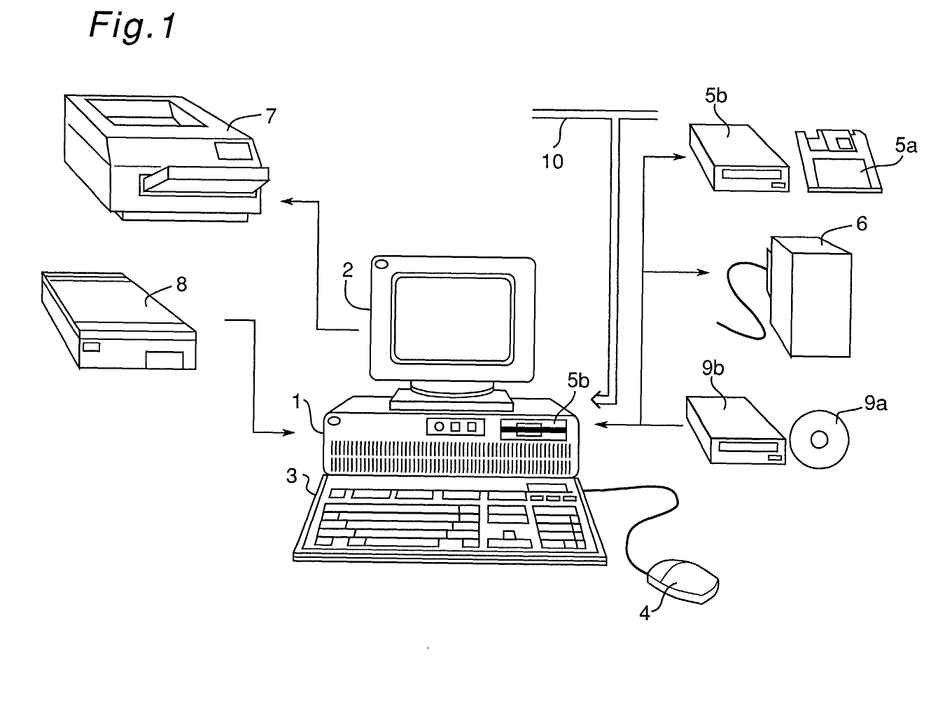

FIG. 1 shows a print system. This system incorporates a function of preventing forgery. In this system, a specified image (shape) or a specified pattern in the image data is detected in input image data or in data obtained by predetermined processing on the input image data, and when the specified image or pattern is detected, the image is inhibited to be reproduced. A computer 1 controls the entire system. The computer 1 has a central processing unit (CPU), a read-only memory (ROM) and a random access memory (RAM). Further, it includes a flexible disk drive 5b, a hard disk drive 6b, and a CD-ROM drive 9b for memory media of a flexible disk 5a, a hard disk and a CD-ROM 9a. A computer program for image processing and a printer driver 120 explained later are read from such a recording medium. The computer 1 is also connected to a scanner 8 as an image input unit for acquiring image data and a printer 7 for printing image data. Further, the computer 1 can be connected to a different image input unit or a different image output unit through a network 10. The above-mentioned system structure is common to other examples explained later. In this system, the program for controlling the system is stored in the CD-ROM 9a as a recording medium. However, it may be read from a different recording medium. The scanner 8 is used as an image input unit, but a different unit such as a digital camera can also be used as an image input unit. Further, the printer 7 is used as an output unit, but a digital copying machine or the like may also be used as an output unit.

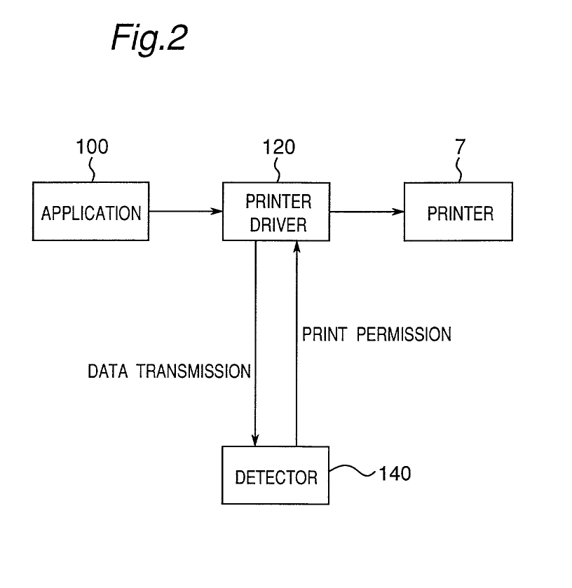

FIG. 2 shows a flow of print data processing. In the print system, the computer 1 has the printer driver 120 and a specified pattern detector 140. The print driver 120 is a computer program which controls the printer. It converts data of characters and images received from the application or the operating system to data which can be interpreted by the printer and outputs the data according to the status of the printer. The printer driver 120 is a component which outputs data including image data in the computer 1 to the printer 7. Practically, when data is edited or confirmed by the application 100, it is sent to the printer driver 120. Then, the print driver 120 converts the data according to the printer characteristics and sends print data to the printer 7. Thus, the image is printed.

When an image is printed, the printer driver 120 in the computer receives image data from the application 100 and sends it to the printer 7. Both of the printer 7 and the printer driver 120 have various performance. In this embodiment, the controller of the printer 7 performs simply to print the as-received data, while the printer driver 120 performs various processing on the image.

In the processing for preventing forgery, data to be checked are image data. As shown in FIG. 2, when the application 100 instructs print of image data, the image data is sent through the printer driver 120 to the printer 7. Practically, after the data is edited or checked by the application, it is sent to the printer driver 120. Then, conversion of the data in correspondence to the printer 7 is performed in the printer driver 120, and the data is printed by the printer 7. For prevention of forgery, a detector 140 is provided further. The printer drier 120 sends input image data to the detector 140. When the specified pattern is not detected, the detector 140 sends print permission command to the printer driver, but when the specified pattern is detected, the detector 140 sends print inhibition command to the printer driver. The output control is performed by taking the print permission signal from the detector 140 into account.

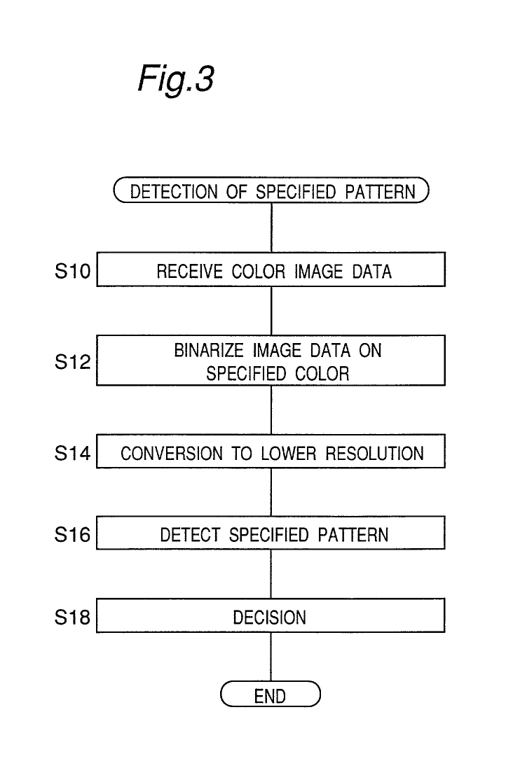

FIG. 3 shows an example of detection of a specified pattern in the specified pattern detector 140. First, a multi-level color image on which detection is performed is received (S10). Next, the color image is binarized (S12). In the binarization of color image, if R (red), G (green) and B (blue) values of a pixel is within a predetermined range, a bit for the pixel is set to “on”, otherwise the bit is set to “off”. For example, if the following conditions are satisfied, the bit for the pixel is set to “on”.

RedMax>R>RedMin,

GreenMax>G>GreenMin,

And

BlueMax>B>BlueMin,

wherein R, G and B represents pixel values of an object pixel, RedMax, GreenMax, and BlueMax represent upper limits of R, G and B, and RedMin, GreenMin, and BlueMin represent lower limits of R, G and B. Next, in order to process the data more efficiently, the resolution (degree of fineness) of the image data as an object of the recognition is decreased to a lower but sufficient resolution for the image analysis (S14).

Next, in order to detect a specified pattern (for example, a circular pattern of a predetermines size), the bi-level image is scanned with a filter successively, and the specified pattern is detected with pattern matching (S16) Then, based on the result of the pattern matching, it is decided to permit output of the image or not (Sl8). If the degree of matching with the specified pattern is large, it is decided that the image is prohibited to be outputted.

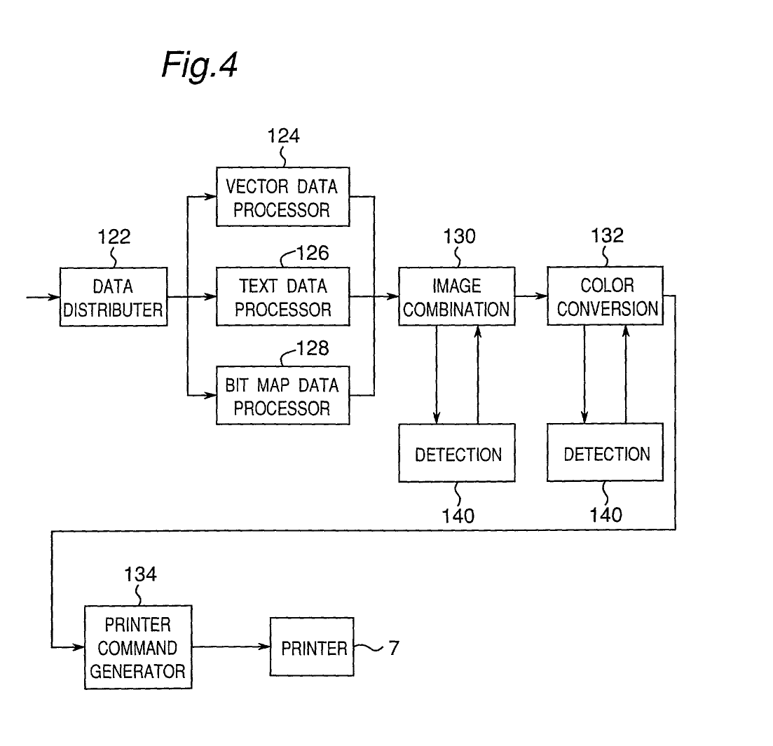

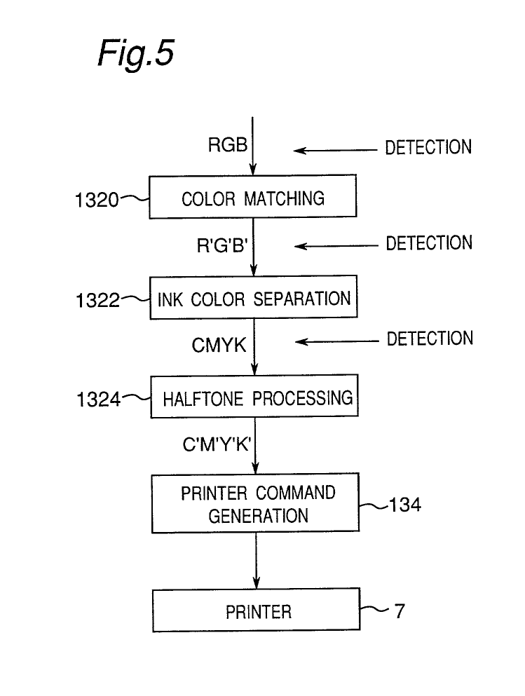

FIG. 4 shows a conversion by the printer driver 120 of print data received from the application 100 to output data to be sent to the printer 7. FIG. 4 shows processings in the printer driver 120 as functional blocks. First, a data distributor 122 analyses input data (print data) and distributes the data according to data type. If the input data is a vector data, the vector data is expanded to bit map data by a vector data processor 124 based on calculation on the vector. If the input data is a text data, the text data is expanded to bit map data by a text data processor according to font size, font data and the like stored in the ROM. If the input data is bit map data, the input data is loaded to bit map data to be outputted by a bit map data processor 128 by taking the position, overlapping and resolution into account. An image combiner 130 combines the bit map data received from the processors 124, 126, 128 to generate bit map data of one page. The developed bit map data is sent to a detector 140. The detector detects whether a specified pattern is included or not and returns the detection result. Because the image combiner 130 is located at a position where all the image data passes, the detector 140 receives image data at that position so that all the image data can be acquired. (The detector 140 may be located at a position in the color change processor 132, as will be explained later with reference to FIG. 5.) Next, the color change processor 132 converts the multi-level RGB data to CMYK data of print colors in correspondence to the characteristics of the printer 7. Next, a printer command generator 134 generates a printer control command and sends it to the printer 7. If necessary, CMYK data are sent to the printer 7. ##

In this example, because the detector 140 receives data from the image combiner 130, all the image data can be acquired. On the contrary, if the detector were provided in the bit map processor 128, the detection would be performed on the input bit map data, but if an image inhibited to be outputted is a vector data, it could not be detected, or correct detection would be impossible. Further, because character information consisting of text data is processed by a text data processor 126, the detection is impossible if an image inhibited to be outputted is a bit map font.

Next, detection in the color change processor 132 which converts multi-level RGB input data to CMYK data outputted to the printer is explained with reference to FIG. 5. The color change processor 132 includes a color matching processor 1320, an ink color processor 1322 and a halftone processor 1324. The detection is performed in correspondence to print output colors. Therefore, if it is not known what input multi-level image data becomes a specified color in a print, correct detection of the specified color is impossible. Then, the detection is performed by receiving image data at a location where the output color of the printer in correspondence to the multi-level data is known. Because color parameters of the specified pattern used for the detection are generated by taking the correspondence with the output color into account, the position where the detection is introduced at a position depending on the method adopted by the print system for the color matching. The color parameters are set according to the print output color. That is, the scanner 8 reads a color chart, and the printer 7 prints it. By measuring the print output, correspondence of the input image signals with the print output color is determined. Then, the color parameters are set according to the result.

If the printer 7 supports sRGB, the input image RGB values can be correlated with the print output color. Therefore, the detection is performed on the input RGB data at a stage where RGB data as image data are received by the color changer 132.

Next, the color matching component 1320 performs color matching on the RGB data, and outputs the result R′G′B′ thereof. When color matching correspondence of a profile is used, the correspondence of the print data with R′G′B′ values can be given by the profile. Then, the detection is performed on the R′G′B′ image data.

Next, at the ink color processor 1322, the R′G′B′ data are converted to data of ink colors of cyan (C), magenta (M), yellow (Y) and black (K). IF a table of the CMYK data and the output colors of the printer is available and if a relationship between them can be obtained, the detection can be performed on the CMYK data.

Next, the halftone processor 1324 performs halftone processing on the CMYK data and outputs the processed data C′M′Y′K′. After the halftone processing, the pixel values cannot be correlated with the output color, or the detection is difficult. Thus, on the data after subjected to the detection, a print command generator 134 generates a print command and sends the print command and the C′M′Y′K′ data to the printer 7. As the printer driver having the above-mentioned function, for example, a driver for serial printer such as an ink jet printer or a dot impact printer may be used.

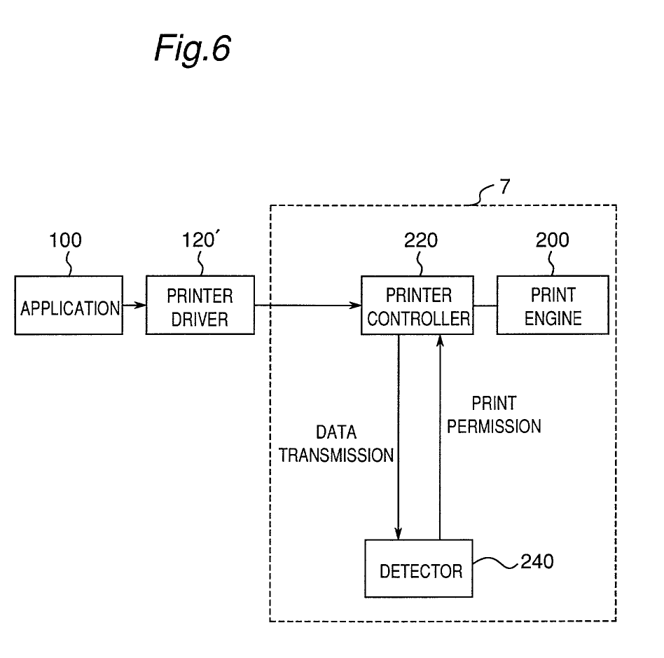

FIG. 6 shows a print system of a second example. In this print system, a printer driver 120′ in the computer converts data received from an application 100 to a page description language which can be interpreted by the printer 7. Then, a printer controller 220 converts the page description language received from the computer to print data. Practically, the printer has a print engine 200, the printer controller 220 and a detector 240. The printer controller 220 performs the conversion in correspondence to the characteristics of the print engine 200 and sends the print data to the print engine 200. The detector 240 performs similar processing as the detector 140 in the first example. The print controller 220 sends the input image data to the detector 240. When the detector 240 does not detect the specified pattern, it sends a print permission command, while when it detects the specified pattern, it sends a print inhibition command to the print controller 220. The print controller 220 performs output control according to the print permission signal from the detector 240.

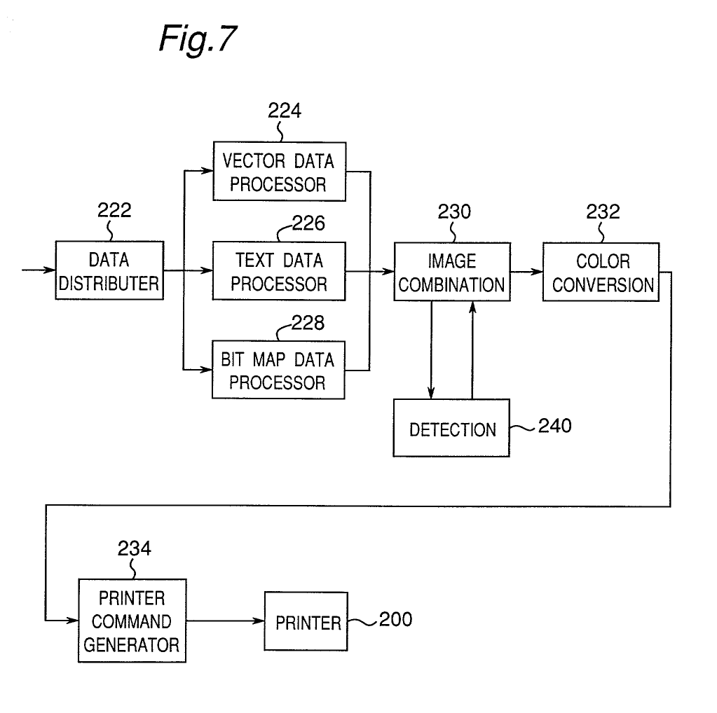

FIG. 7 shows conversion to the data outputted to the printer when print data are received from the print driver 120′ in the computer. The processing from the data distributor 222′ to the printer command generator 234′ is similar to the counterpart from the data distributor 122 to the printer command generator 134 and the explanation thereof is omitted here. However, it is to be noted that the detection by the detector 240 is performed on the data obtained by the image combiner 230.

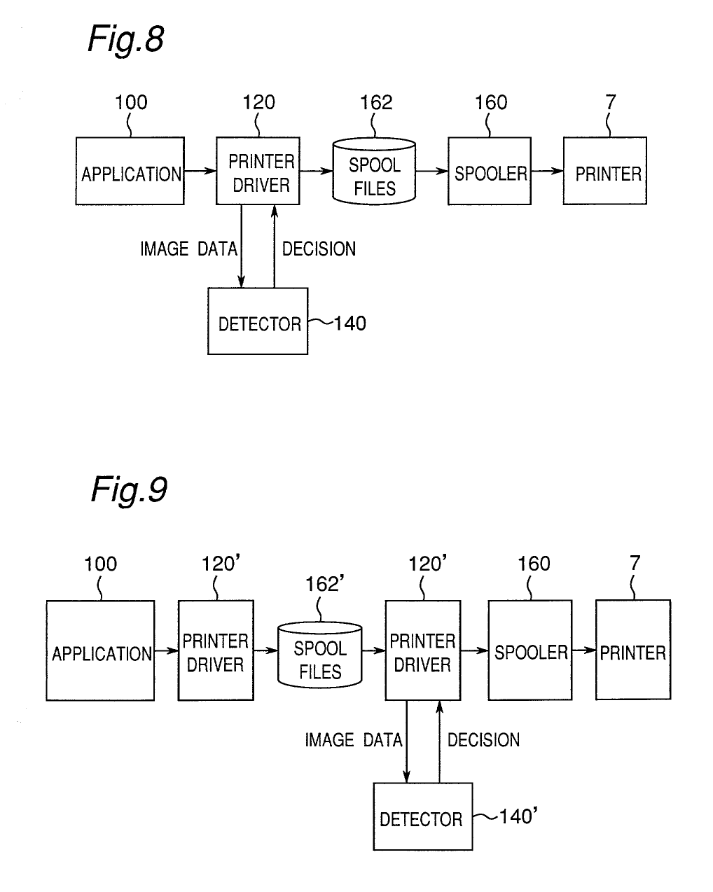

FIG. 8 shows a print system where a command for printer control generated by the printer driver through a spooler. When an application 100 instructs print, data to be printed are stored in a spool file 162 in a spooler 160 through the printer driver 120. The printer driver 120 sends image data to the detector 140, and the detector 140 send the result of the detection to the printer driver 120. Thus, the detector 140 performs the detection before generating a spool file 162. The data of pages to be outputted after subjected the detection are stored in the spool file 162. Therefore, the output to the printer 7 can be controlled according to the result of the detection. The file in the spooler 160 is printed at the printer 7. Because the detection is performed at the upstream side of the spool file, image output can be inhibited before printing.

In this example, data of pages to be outputted after subjected to the detection are stored in the spool file. Because the detector 140 is located at the upstream side than the spool file 162, the control in the unit of page is possible. The control of permission/inhibition of output in the unit of page is carried out as follows.

(a) First method: The printer driver 120 sets a flag of permission/inhibition for each page. The spooler 160 outputs only the permitted pages to the printer 7.

(b) Second method: The printer driver 120 sends a signal of permission/inhibition for each page to the spooler 160. The spooler 160 outputs only the permitted pages to the printer 7.

FIG. 9 shows another print system wherein a print control command generated by a printer driver is sent through a spooler. Only different points from the system shown in FIG. 8 is explained here. In this system, data to be printed by a printer driver 120′ is converted to a draw command and stored in a spool file 162′. Then, the printer driver 120′ converts the draw command to a data to be outputted to the printer 7 and sends the data to a detector 140′. The detector 140′ sends the result of detection to the printer driver 120′.

As explained above on various examples, an image is detected at a position where image data to be outputted passes necessarily. Therefore, the detection of an image which has to be inhibited to be outputted is not missed. That is, the image data will not by-pass the position, so that forgery can be prevented surely.

Further, because the detection is performed at a position where the input values corresponds to an output color, a color range of a specified color to be detected can be determined. Therefore, an image having a color close to the original one can be detected surely. On the other hand, an image having a color not similar to the original one is not detected, and erroneous detection is prevented.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. An image processor which processes input data and outputs the processed data to an image output device comprising:
a first converter which converts the input data to output data by processing the input data according to data type; and
a detector which detects a specified pattern in the data after converted by said first converter, wherein all the data converted by said first converter passes said detector.

2. The image processor according to claim 1, further comprising a controller which controls the output of the data converted by said first converter according to a result of the detection by said detector.

3. The image processor according to claim 1, wherein said first converter converts the input data to bit map data to be outputted.

4. The image processor according to claim 3, wherein when the input data is a vector data, said first converter converts the vector data to bit map data by calculation on the vector data and when the input data is a text data, said first converter converts the text data to bit map data with reference to font data.

5. The image processor according to claim 1, further comprising an image combiner which combines the data converted by said first converter according to data type to generate an image data, wherein said detector detects the specified pattern in the image data generated by said image combiner.

6. The image processor according to claim 1, further comprising a second converter which converts the data converted by said first converter according to data type to data of output colors of an image output device, wherein said detector detects the specified pattern in the data which has been converted by said second converter.

7. The image processor according to claim 1, wherein said first converter and said detector are incorporated in a driver for an image output device.

8. A print system having an image processor which processes data and a printer which prints data received from said image processor, comprising:
a first converter which converts the input data to output data by processing the input data according to data type; and
a detector which detects a specified pattern in the data after converted by said first converter, wherein all the data converted by said first converter passes said detector.

9. The print system according to claim 8, wherein said first converter converts the input data to bit map data to be outputted.

10. The print system according to claim 9, wherein when the input data is a vector data, said first converter converts the vector data to bit map data by calculation on the vector data and when the input data is a text data, said first converter converts the text data to bit map data with reference to font data.

11. The print system according to claim 8, further comprising an image combiner which combines the data converted by said first converter according to data type to generate an image data, wherein said detector detects the specified pattern in the data generated by said image combiner.

12. The print system according to claim 8, further comprising a second converter which converts the data converted by said first converter according to data type to data of output colors of an image output device, wherein said detector detects the specified pattern in the data which has been converted by said second converter.

13. The print system according to claim 8, wherein said image processor comprising a printer driver, and said first converter and said detector are incorporated in said printer driver.

14. The print system according to claim 8, wherein said printer comprises a printer controller which controls said printer, and said first converter and said detector are incorporated in said printer controller.

15. A method of image processing which processes input data and outputs the processed data to an image output device, comprising the steps of:
converting the input data to output data by processing the input data according to data type; and
detecting a specified pattern in the converted data, wherein all the converted data is detected.

16. A storage medium storing a computer-executable program comprising the steps of:
converting input data to output data by processing the input data according to data type; and
detecting a specified pattern in the converted data, wherein all the converted data is detected.
